(19) United States
(12) Patent Application Publication
(10) Pub. No.: US 2023/0403592 A1
(43) Pub. Date: Dec. 14, 2023

(54) SYSTEMS AND METHODS FOR BANDWIDTH PART AND BEAM SWITCHING FOR NON-TERRESTRIAL NETWORKS

(71) Applicant: Telefonaktiebolaget LM Ericsson (publ), Stockholm (SE)

(72) Inventors: Hazhir SHOKRI RAZAGHI, Solna (SE); Xingqin LIN, San Jose, CA (US)

(21) Appl. No.: 18/249,331

(22) PCT Filed: Oct. 20, 2021
(86) PCT No.: PCT/SE2021/051047

§ 371 Date: Apr. 17, 2023

Related U.S. Application Data
(60) Provisional application No. 63/105,011, filed on Oct. 23, 2020.

(51) Int. Cl. H04W 24/10; H04W 24/08

(52) U.S. Cl. CPC H04W 24/10; H04W 24/08

(57) ABSTRACT

A method by a wireless device includes performing at least one measurement on at least one non-active bandwidth part (BWP) while the wireless device is in connected mode.

### TECHNICAL FIELD

The present disclosure relates, in general, to wireless communications and, more particularly, systems and methods for bandwidth part and beam switching for Non-Terrestrial Networks (NTNs).

### BACKGROUND

In 3rd Generation Partnership Project (3GPP) Release 8, the Evolved Packet System (EPS) was specified. EPS is based on the Long-Term Evolution (LTE) radio network and the Evolved Packet Core (EPC). It was originally intended to provide voice and mobile broadband (MBB) services but has continuously evolved to broaden its functionality. Since Release 13, Narrowband-Internet of Things (NB-IoT) and LTE for machine type communication (LTE-M) are part of the LTE specifications and provide connectivity to massive machine type communications (mMTC) services.

In 3GPP Release 15, the first release of the 5G system (5GS) was specified. This is a new generation's radio access technology intended to serve use cases such as enhanced mobile broadband (eMBB), ultra-reliable and low latency communication (URLLC) and mMTC. 5G includes the New Radio (NR) access stratum interface and the 5G Core Network (5GC). The NR physical and higher layers are reusing parts of the LTE specification, and to that add needed components when motivated by new use cases. One such component is the introduction of a sophisticated framework for beam forming and beam management to extend the support of the 3GPP technologies to a frequency range going beyond 6 GHz.

In Release 15, 3^{rd} Generation Partnership Project (3GPP) started the work to prepare New Radio (NR) for operation in Non-Terrestrial Networks (NTN). NTN is a network typology where network nodes, e.g. base stations, base station repeaters and base station relays, are aerial and in full or in part located in flying vehicles such as satellites, high-altitude platforms (HAPS) or drones. The work was performed within the study item “NR to support Non-Terrestrial Networks” and resulted in. See, TR 38.811, “Study on New Radio (NR) to support non-terrestrial networks (NTN)”.

In Release 16, the work to prepare NR for operation in an NTN network continued with the study item “Solutions for NR to support Non-Terrestrial Network”. See, TR 38.821 V16.0.0 “Solutions for NR to support non-terrestrial networks (NTN)”, 2019. In parallel, the interest to adapt Narrowband-Internet of Things (NB-IoT) and Long Term Evolution for Machine Type Communication (LTE-M) for operation in NTN is growing. As a consequence, 3GPP Release 17 contains both a work item on NR NTN and a study item on NB-IoT and LTE-M support for NTN. See, RP-193234, Solutions for NR to support non-terrestrial networks (NTN), 3GPP RAN #86. See, RP-193235, Study on NB-IoT/eMTC support for Non-Terrestrial Network, 3GPP RAN #86.

A satellite radio access network is one type of NTN and usually includes the following components:
A satellite that refers to a space-borne platform.
An earth-based gateway that connects the satellite to a base station or a core network, depending on the choice of architecture.
Feeder link that refers to the link between a gateway and a satellite.
Service link that refers to the link between a satellite and a UE.

Depending on the orbit altitude, a satellite may be categorized as low earth orbit (LEO), medium earth orbit (MEO), or geosynchronous earth orbit (GSO) satellite:
LEO: typical heights ranging from 250-1,500 km, with orbital periods ranging from 90-120 minutes.
MEO: typical heights ranging from 5,000-25,000 km, with orbital periods ranging from 3-15 hours.
GSO: height at about 35,786 km, with an orbital period of 24 hours.

FIG. 1 illustrates an example architecture of a satellite network based on the bent pipe architecture in which the satellite transponders are said to be transparent. In practice, this implies that the satellite transponder corresponds to frequency shifting repeater. The depicted elevation angle of the service link is important as it affects the distance between the satellite and the device, and the velocity of the satellite relative to the device.

The satellite device is depicted in FIG. 1 as a regular handheld device. This is true for a subset of the NTN use cases categorized as mobile satellite services (MSS), which are commonly associated with voice, text messaging and low data rate services. Fixed satellite services (FSS) which are able to offer higher data rates are associated with the use of large antenna aperture devices supporting highly directional antenna beams with beam widths in the order of a degree. FSS devices are often referred to as very small aperture terminals (VSAT).

A communication satellite typically generates several beams over a given area. The footprint of a beam is usually in an elliptic shape, which has been traditionally considered as a cell. The footprint of a beam is also often referred to as a spotbeam. The spotbeam may move over the earth surface with the satellite movement or may be earth fixed thanks to some beam pointing mechanism used by the satellite to compensate for its motion. At some point, such as, for example, as the serving satellite approaches the horizon, the service link then needs to switch from the first serving satellite to a second serving satellite. FIG. 2 illustrates service link switching for case of earth fixed beams. The movements of the satellites are illustrated using vectors, v.

NR defines scalable orthogonal frequency division multiplexing (OFDM) numerologies using subcarrier spacing (SCS) of 2^{μ}·15 kHz (μ=0, 1, . . . , 4). A resource block (RB) consists of 12 consecutive subcarriers in the frequency domain. A BWP starts at a certain RB and consists of a set of contiguous RBs with a given numerology (SCS and cyclic prefix) on a given carrier. For each serving cell of a user equipment (UE), the network configures at least one downlink (DL) BWP. The network may configure the UE with up to four DL BWPs, but only one DL BWP can be active at a given time. If the serving cell is configured with an uplink (UL), the network configures at least one UL BWP. Similar to the DL, the network may configure the UE with up to four UL BWPs, but only one UL BWP can be active at a given time.

For paired spectrum, i.e., frequency division duplex (FDD), DL BWPs and UL BWPs are configured separately. For unpaired spectrum, i.e., time division duplex (TDD), a DL BWP is linked to an UL BWP when the indices of the two BWPs are the same. In this case, the paired DL BWP and UL BWP must share the same center frequency, but they can have different bandwidths.

The initial DL and UL BWPs are mainly used by UE for initial access before radio resource control (RRC) connection is established. An initial BWP has index zero and is referred to as BWP #0. During the initial access, the UE performs cell search based on synchronization signal block (SSB) composed of primary synchronization signal (PSS), secondary synchronization signal (SSS), and physical broadcast channel (PBCH). To access the system, the UE needs to further read system information block 1 (SIB1) which carries important information including the initial DL/UL BWP configuration. The SIB1 is transmitted on the PDSCH, which is scheduled by downlink control information (DCI) on the PDCCH using the control resource set with index zero (CORESET #0).

Before the UE reads the SIB1, the UE's initial DL BWP has the same frequency range and numerology as those of CORESET #0. After reading the SIB1, the UE follows the initial DL/UL BWP configuration in the SIB1 and uses them to carry out random-access procedure to request the setup of RRC connection. The network should configure the frequency domain location and bandwidth of the initial DL BWP in the SIB1 so that the initial DL BWP contains the entire CORESET #0 in the frequency domain.

In 3GPP TR 38.821, it is shown that frequency, and/or polarization, reuse can bring in significant improvement in operating signal-to-interference ratio (SIR), compared to universal frequency and polarization reuse. It has been proposed that the BWP concept in NR can provide flexible frequency reuse configuration and facilitate mobility management between the areas covered by the different BWPs. FIG. 3 illustrates BWP based frequency reuse in NTN. As illustrated in FIG. 3, BWP #0 covers the entire cell and additional BWPs can be dynamically configured to cover different parts of the cell. To have cell wide coverage for BWP #0, a wide beam for BWP #0 can continuously cover the full cell (as illustrated in FIG. 3), or a narrow beam can cover different parts of the cell with a time multiplexed pattern to produce cell wide coverage for BWP #0. The additional and non-overlapping BWPs can be mapped to different beams to create a frequency-reuse.

In one carrier, multiple cells with different NR global cell identities (NCGIs) may be present in the DL bandwidth of the carrier. 3GPP TS 38.300 Appendix B describes one such example. See, TS 38.300 V16.2.0, “NR; NR and NG-RAN Overall Description”, July 2020. For a UE in RRC_CONNECTED, the BWPs configured by a serving cell may overlap in the frequency domain with the BWPs configured for other UEs by other cells within a carrier. Multiple SSBs may also be transmitted within the frequency span of a carrier used by the serving cell. However, from the UE perspective, each serving cell is associated to at most a single SSB. FIG. 4 describes a scenario with multiple SSBs in a carrier, identifying two different cells (NCGI=5, associated to SSB #1, and NCGI=6, associated to SSB #3) with overlapping BWPs, and where RRM measurements can be configured to be performed by the UE on each of the available SSBs, i.e. SSB #1, SSB #2, SSB #3 and SSB #4.

To overcome the challenging propagation conditions in FR2, NR supports advanced beamforming techniques. Important pillars in the overall NR beamforming technology are the concepts of quasi co-location (QCL) and transmission configuration indication (TCI) which are introduced in the next two sections. The QCL concept was originally specified for LTE and is evolved in the NR specifications.

To enable a receiver to infer the channel over which a first symbol, which is transmitted from a first antenna port, is conveyed, and the channel over which a second symbol, which is transmitted from a second antenna port, is conveyed, a UE may assume that the two antenna ports are quasi co-located (QCL). Generally, several signals can be transmitted from the same base station physical antenna from different antenna ports. These signals may share the same large-scale properties, for instance in terms of Doppler shift/spread, average delay spread, or average delay. These antenna ports are then said to be quasi co-located.

A technical specification can determine, or a network can signal to a UE, that two antenna ports are QCL. If the UE knows that two antenna ports are QCL with respect to a certain parameter the UE can estimate that parameter based on a source signal transmitted from a first antenna port and use that estimate when receiving a target signal from a second antenna port. Typically, the first antenna port is represented by a measurement reference signal (RS) such as channel state information reference signal (CSI-RS) and the second antenna port is represented by a demodulation reference signal (DMRS).

For instance, if antenna ports A and B are QCL with respect to average delay, the UE can estimate the average delay from the source RS received from antenna port A, and assume that the target RS received from antenna port B has the same average delay. This a-priori information is useful for a UE when demodulating a signal sent from antenna port B.

There are 4 QCL types defined in NR comprising the following channel properties:
QCL-Type A: {Doppler shift, Doppler spread, average delay, delay spread}
QCL-Type B: {Doppler shift, Doppler spread}
QCL-Type C: {Doppler shift, average delay}
QCL-Type D: {Spatial Rx parameter}

NR QCL-Type A is similar to QCL-Type A specified for LTE. QCL-Type B and QCL-Type C include a subset of the channel statistical properties defined for QCL-Type A. One distinct feature of NR compared to LTE is the operation in FR2, which requires highly directional beamformed transmissions and receptions. QCL-Type D is introduced to facilitate beamforming operation in NR FR2. It is associated to the spatial receiver filter, i.e. the receiver beam, configuration used by a UE for receiving NR signals and channels. If a target DMRS of a PDSCH transmission is quasi co-located with a source RS according to QCL-Type D, the UE may use the same spatial receiver filter configuration for receiving both the source RS and the target PDSCH DMRS.

In NR, the use of the QCL concept has been extended by the introduction of transmission configuration indication (TCI) states. A TCI state uses the QCL-Info parameter to configure QCL relationships between up to two downlink reference signals and the DM-RS ports of PDCCH and PDSCH transmissions. Each QCL-Info information element identifies one of the downlink reference signals and configures the QCL type associated to it. The reference signal corresponds to a CSI-RS or synchronization signal block (SSB), while the QCL is determined as one of QCL types A-D. 3GPP TS 38.331 defines the TCI-state information element. See, TS 38.331 V16.1.0, “Radio Resource Control (RRC) protocol specification”, July 2020.

The association between the TCI state and PDSCH transmissions is on a first level defined by a list of available TCI states which is configured for PDSCH by means of Radio Resource Control (RRC) signaling. Each listed TCI state containing QCL type D can be interpreted as a possible PDSCH carrying beam transmitted from the network. A second list is created for PDCCH using a subset of the TCI states configured for PDSCH.

The network activates one of the listed TCI states to be associated with future PDCCH transmissions, by means of Medium Access Control (MAC) signaling. This effectively quasi co-locates the antenna ports of the source reference signal, identified by the activated TCI state QCL-info, with the target reference signal, i.e. the PDCCH DMRS, antenna ports.

The network also uses MAC signaling to select and activate a sub-set of 8 TCI states from the RRC list that are relevant for future PDSCH transmissions. The UE is expected to continuously track and update the channel properties for the active TCI states by measurements and analysis of the source RSs indicated by each TCI state. The actual TCI state to be assumed at PDSCH reception is indicated by means of physical (PHY) layer downlink control information (DCI) signaling or is configured to be the same as that used for PDCCH reception.

The RRC, MAC and PHY signaling framework supports a dynamic configuration of TCI states to facilitate dynamic beamforming for PDCCH and PDSCH transmissions.

The UE performs measurements in both idle/inactive and connected modes to determine the strength of the reference signals sent by the gNodeB (gNB). However there are subtle differences between measurement procedures in these states and the purpose of these measurements. For RRC connection maintenance, three different types of measurements exist:
1. Reference Signal Received Power (RSRP) is defined in relation to the reference signal used for the measurement, and as the linear average over the power contributions (in [W]) of the resource elements that carry that reference signals. For example, Synchronization Signal-Received Signal Received Power (SS-RSRP) is defined for measurements performed on Secondary synchronization signals of SSB, or Channel State Information-Received Signal Received Power (CSI-RSRP) for CSI-RS configured for RSRP measurements. However, for specific some measurements other signals can be configured in addition to the main RS e.g. for SS-RSRP, PBCH DMRS and CSI-RS can be configured besides the secondary synchronization signal to perform the measurements.
2. Reference Signal Received Quality (RSRQ) is defined in terms of ratio of measured RSRP to the measured Reference Signal Strength Indicator (RSSI) value, where RSSI is defined as linear average of total received power (in [W]) over the measurement bandwidth at UE from all sources including non-serving cell, thermal noise, adjacent channel interference, etc. e.g. Channel State Information-Received Signal Received Quality (CSI-RSRQ) is the ratio of Channel State Information-Received Signal Received Power (CSI-RSRP) to Channel State Information-Received Signal Strength Indicator (CSI-RSSI) where CSI-RRSI is the average received total power over the resource blocks configured for CSI-RS.
3. Signal to Interference Plus Noise Ratio (SINR) is defined in relation to the reference signal used for the measurement, and as the ratio of RSRP of the reference signal to the linear average of the noise and interference power contribution (in [W]). For Layer 1-SINR (L1-SINR) reporting purposes, if dedicated interreference resources are configured the interference and noise are measured over those resources. Otherwise, it is measured over the resource elements carrying corresponding reference signal. According to the specification SINR measurements are applicable only in connected mode.

See, TS 38.215 V16.2.0 “Physical layer measurements”, July 2020. In RRC connected mode, the UE already has an established connection, and it can be configured to perform measurements and to report back the measurement results. The measurements in connected mode is used by the gNB to assess the state of the UE RRC connection and whether there is a need for modification of the connection including beam switching, handover, adding or modifying secondary cells, etc. The main purpose of the RRC connected measurements is for network-controlled mobility which is categorized into two types: cell level mobility and beam level mobility. In each case, the gNB configures reference signal resource and measurement reporting related parameters. Only cell-level mobility requires explicit RRC signaling for triggering the handover, while beam level switching is dealt with by lower layer that is physical and MAC layer control signaling. In connected mode, measurement can be performed either on SSB or single-port CSI-RS. Also, all three types of measurements, i.e. RSRP, RSRQ and SINR, are applicable in connected mode.

In order to achieve required accuracy for the measurement defined in the specification and also mitigating the fast fading effects, the UE performs filtering (or averaging) in two stages. First is Layer 1 filtering or L1-filtering, which is beam specific. It is up to the UE implementation on how and when to perform this filtering. However, the output of the filtering reported to Layer 3 (L3) for beam consolidation/selection should fulfill the measurement period and accuracy metrics as specified in the standards. See, TS 38.133 V16.5.0 “Requirements for support of radio resource measurement”, September 2020. L3 filtering is defined in the specifications and it consists of one tap Moving Average (MA) process of current and old filtered measurements. See, TS 38.331 V16.1.0, “Radio Resource Control (RRC) protocol specification”, July 2020. The coefficient of the filter is configured by RRC signaling based on the type of measurement. Also, the L3-filtering could be done for cell quality as well as per beam level at different stage of the measurements.

Another important procedure for performing measurements is to configure measurement gaps so that the UE can perform measurements on the neighboring cell and not receiving or transmitting data on the serving cell at the same time. Measurement gap, however, can be used for intra-frequency measurements as well e.g. the reference signal is not within the active BWP of the UE. In NR, we consider measurements as intra-frequency under the following conditions depending on the reference signal type, otherwise they are defined as inter-frequency:
If the center frequency as well as SCS of the SSB block of neighboring cell is the same as that of the serving cell.
If bandwidth of the configured CSI-RS resources of the serving cell is within the bandwidth of configured CSI-RS of the neighboring cell, and the SCS of the two cells are the same.

### See, TS 38.300 V16.2.0, “NR; NR and NG-RAN Overall Description”, July 2020.

For SSB measurement in inter-frequency scenario, measurement gaps are always provided if the UE only supports per-UE measurement gaps or UE supports per-FR measurement gaps and any of the serving cells are within the provided measurement bandwidth. For SSB measurement, in intra-frequency measurement gaps are always provided if any of the UE configured dedicated BWPs (not the initial BWP though) do not contain the frequency of the SSB associated to the initial DL BWP. For both scenarios, the gaps may be provided if UE reports it measurement gap requirements.

In RRC idle/inactive mode, the UE has no active RRC connection. In this state, the UE performs measurements for finding a suitable cell to camp on (i.e., cell selection) and after that, monitors the selected cell and other available cell for idle/inactive mode mobility (i.e., cell reselection). However, the UE does not report any measurement results to the gNB. In idle/inactive mode, measurements are performed only over SSB signals as there is no established RRC connection in order to configure CSI-RS resources. Also, the UE performs only RSRP and RSRQ for cell selectin/reselection although no report is sent back to the network as mentioned above.

Certain problems exist. For example, the BWP framework in NR is used for frequency reuse. Furthermore, some association is defined between a beam and a BWP, and there are procedures defined in NR for both beam and BWP switching. However, the following problems are not addressed in the specification which are relevant specifically for NTN use cases:
UE cannot perform measurements on non-active BWP according to current specification which might be required for efficient performance under BWP based frequency reuse.
In a NTN network, it is likely that UE have access to ephemeris data, and along with GNSS information, they are used for different procedures for the NTN Network. However, currently there is no specification defined to use this for BWP and/or beam switching
For realization of NTN frequency reuse scheme, each beam can be associated with a BWP, for which the detail design and signaling need to be specified.
There is a need in specification to define procedures for simultaneous switching of a BWP and its associated beam.

### SUMMARY

Certain aspects of the present disclosure and their embodiments may provide solutions to these or other challenges. For example, according to certain embodiments, methods and systems are provided for supporting BWP and beam management operation in NTN with frequency reuse. In particular, methods and systems are provided for the UE to measure non-active BWPs, according to certain embodiments. Additionally, methods and systems are provided for BWP and beam switching using satellite ephemeris and UE GNSS, according to certain embodiments. Methods and systems are also provided for associating BWP and beam to support simultaneous beam and BWP switching, according to certain embodiments.

According to certain embodiments, a method by a wireless device includes performing at least one measurement on at least one non-active BWP while in a connected mode.

According to certain embodiments, a wireless device is adapted to perform at least one measurement on at least one non-active BWP while in a connected mode.

According to certain embodiments, a method by a wireless device includes obtaining ephemeris and/or GNSS information and performing BWP switching procedure based on the ephemeris and/or GNSS information.

According to certain embodiments, a wireless device is adapted to obtain ephemeris and/or GNSS information and perform BWP switching procedure based on the ephemeris and/or GNSS information.

According to certain embodiments, a method by a wireless device includes defining an association between a BWP and at least one beam.

According to certain embodiments, a wireless device is adapted to define an association between a BWP and at least one beam.

According to certain embodiments, a method by a network node includes configuring a wireless device in a connected mode to performing at least one measurement on at least one non-active BWP.

According to certain embodiments, a network node is adapted to configure a wireless device in a connected mode to performing at least one measurement on at least one non-active BWP.

According to certain embodiments, a method by a network node includes obtaining ephemeris and/or GNSS information and determining a need for performing a BWP switching procedure based on the ephemeris and/or GNSS information.

According to certain embodiments, a network node is adapted to obtain ephemeris and/or GNSS information and determine a need for performing a BWP switching procedure based on the ephemeris and/or GNSS information.

According to certain embodiments, a method by a network node includes obtaining an association between a BWP and at least one beam.

According to certain embodiments, a network node is adapted to obtain an association between a BWP and at least one beam.

Certain embodiments may provide one or more of the following technical advantages. For example, one technical advantage may be that certain embodiments enable efficient BWP and beam management operation in NTN with frequency reuse. Using beam management may help reduce L3 handover as L3 handover may be signaling heavy in low-Earth orbit satellite networks. As another example, a technical advantage may be that certain embodiments use BWP to enable frequency reuse helps manage inter-beam interference and can flexibly adapt to traffic distribution on the ground.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates an example architecture of a satellite network based on the bent pipe architecture in which the satellite transponders are said to be transparent;

FIG. 2 illustrates service link switching for case of earth fixed beams;

FIG. 3 illustrates BWP based frequency reuse in NTN;

FIG. 4 illustrates a scenario with multiple SSBs in a carrier, identifying two different cells with overlapping BWPs;

FIG. 5 illustrates an example wireless network, according to certain embodiments;

FIG. 6 illustrates an example network node, according to certain embodiments;

FIG. 7 illustrates an example wireless device, according to certain embodiments;

FIG. 8 illustrate an example user equipment, according to certain embodiments;

FIG. 9 illustrates a virtualization environment in which functions implemented by some embodiments may be virtualized, according to certain embodiments;

FIG. 10 illustrates an example method by a wireless device, according to certain embodiments;

FIG. 11 illustrates another example method by a wireless device, according to certain embodiments;

FIG. 12 illustrates another example method by a wireless device, according to certain embodiments;

FIG. 13 illustrates an example method by a network node, according to certain embodiments;

FIG. 14 illustrates another example method by a network node, according to certain embodiments; and

FIG. 15 illustrates another example method by a network node, according to certain embodiments.

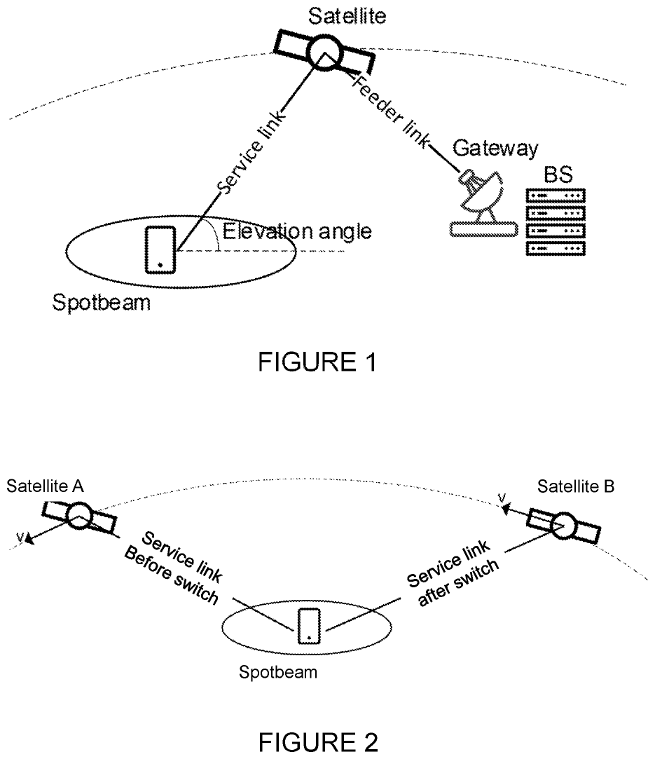

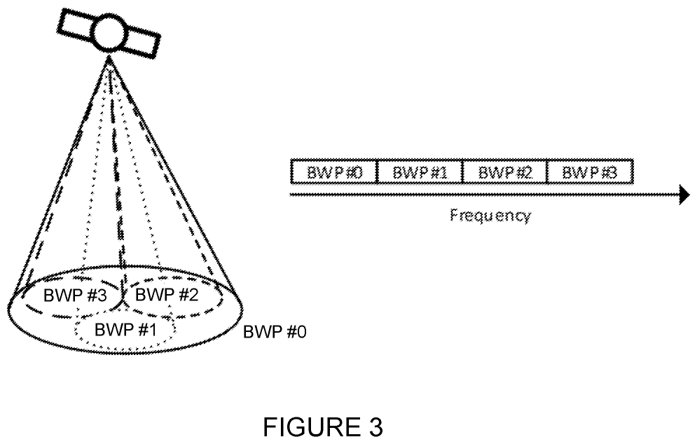

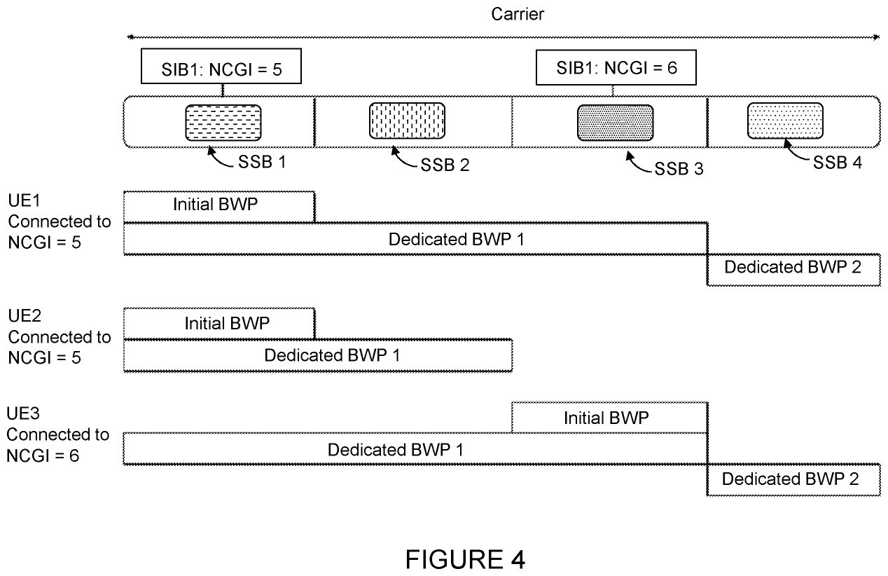

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. MSC, MME, etc.), O&M, OSS, SON, positioning node (e.g. E-SMLC), MDT, test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNB, or UE.

According to certain embodiments, a wireless device such as, for example, a UE may be allowed to perform measurements on non-active BWPs in connected mode. For this, a wireless device may be configured with SSB and CSI-RS resources for measurements on the non-active BWPs.

In a particular embodiment, the wireless device indicates to the network whether it supports measurements on non-active BWPs. The measurement capability on non-active BWPs may be reported per wireless device, per band, per band combination, or per band in a band combination. A wireless device may signal the non-active BWP measurement capability for FDD and TDD, separately. A wireless device may also signal the non-active BWP measurement capability separately for different frequency ranges (such as frequency range 1 and frequency range 2).

The wireless device may use the same RF module for measurements on non-active BWPs and data transmission/reception on the active BWP. In a particular embodiment, the wireless device indicates to the network whether it needs measurement gaps to perform measurements on non-active BWPs.

In a particular embodiment, the network node may configure a wireless device in RRC Connected with measurement gaps for non-active BWP measurements. These gaps may be defined by a length, a periodicity and a starting offset determined relative to the start of each period. The wireless device is expected to perform measurements on non-active BWPs during these gaps and is not expected to be scheduled on the active BWP during these gaps.

In particular embodiments, the measurement reports on non-active BWP can be periodic, semi-periodic or event triggered. The trigger condition can include but not limiting to
measured RSRP, RSRQ, SNR and/or RSSI of the active BWP fall below a threshold; or
measured pathloss of the active BWP exceeds a threshold; or
distance between UE measured location and a reference point of the cell applicable for the active BWP exceeds a threshold; or
expected serving time for the beams on the active BWP is less than a threshold;
a message (RRC, MAC CE, or DCI) from network that requests for measurement reports; or
any combination of the above.

According to certain embodiments, a wireless device may switch BWP based on the ephemeris/GNSS information. According to various particular embodiments, the procedure may be done but not limited in the following ways:
In a particular embodiment, the wireless device is configured to report its location to the gNB, either periodically or event triggered. The triggering event may for example be that the distance between the wireless device measured location and a reference point of the cell applicable for the active BWP exceeds a threshold. Then, based on the received UE location, satellite ephemeris, and BWP based frequency reuse arrangement, the gNB indicates to the wireless device to switch its active BWP to a different one using RRC reconfiguration, MAC CE, and/or DCI.
In a particular embodiment, the wireless device is informed about the BWP based frequency reuse arrangement. The wireless device also receives satellite ephemeris and measures its location using GNSS. The wireless device is further configured with a condition. When the condition is satisfied, the wireless device executes the BWP switching by itself. The condition may, for example, be that the distance between the wireless device's measured location and a reference point of the cell applicable for the active BWP exceeds a threshold. Alternatively, the condition may be that the distance between the wireless device measured location and a reference point of the cell applicable for a non-active BWP becomes small than a threshold. The wireless device notifies the gNB about its change of active BWP in the form of, for example, MAC CE or an RRC message.

In a particular embodiment, wireless device and/or gNB consider other metrics along with GNSS/ephemeris data to make decision of BWP switching. As examples, such additional or other metrics may include UE measurements, wireless device and gNB serving beam, traffic load, etc.

According to certain embodiments, each BWP is associated with a beam. In various particular embodiments, the association between a BWP and a beam can be defined in one of the following ways:
via a RS such as, for example, CSI-RS, SSB for association between a BWP and a beam, i.e., BWP is tagged with a RS index used for the corresponding beam. This can be done according to one or more of the following examples:
   by defining an RRC parameters and fields, e.g. associatedRSbeam in the BWP IE field, as well as proper RRC signaling, e.g. RRC connection establishment, RRC reconfiguration etc.
   by indicating the association between BWP index and RS defining beam in System information e.g. MIB, SIB1, other SIBs.
   by indicating the association between BWP index and RS defining beam using DCI or MAC CE.
   by implicitly associating a BWP with a RS signal with some specific characteristics such as, for example, a certain time or frequency allocation.
   by predefined values such as, for example, tabular values in specification between RS signal index and BWP index.
by associating TCI state index with BWP index; and/or
by associating Spatial Relation index with BWP index.

In a particular embodiment, the method above may be used in different stage of UE connection such as, for example, connected vs idle/inactive or for different procedures such as, for example Random access, DL control reception, DL data reception, etc.

In a particular embodiment, a BWP is associated with multiple beams. One of the multiple beams associated with the BWP is chosen as the default beam. The default beam can be RRC configured, MAC CE signaled, or DCI indicated. Alternatively, default beam can be implicitly chosen based on a certain rule, such as, for example, the beam with the lowest index.

According to certain embodiments, methods and systems are provided for simultaneous BWP and beam switching by a wireless device such as, for example, a UE.

In a particular embodiment, a wireless device may perform simultaneous BWP and beam switching based on an association such as an association as described above. When the wireless device switches from a first BWP to a second BWP (triggered by switch command in the form of RRC, MAC CE, or DCI, or by some event such as expiration of timer), the wireless device also switches from a first beam associated with the first BWP to a second beam associated with the second BWP.

In a particular embodiment, when a wireless device switches from a first beam to a second beam (triggered by switch command in the form of RRC, MAC CE, or DCI, or by some event such as expiration of timer), the wireless device also switches from a first BWP associated with the first beam to a second BWP associated with the second beam.

According to certain embodiments, systems and methods are provided for the configuration of more than one active BWP for the wireless device. Any of the embodiments described above may be implemented such that more than one active BWP may be configured for the UE.

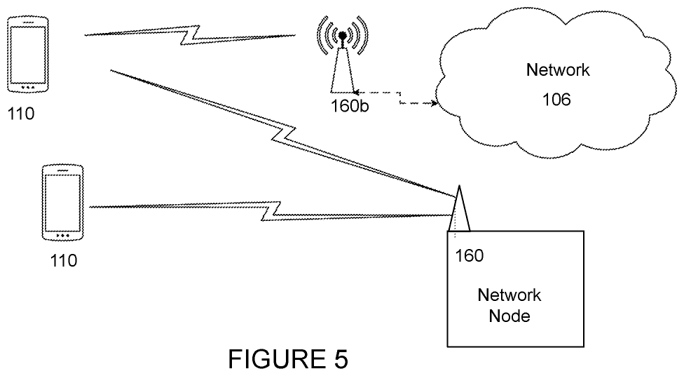

FIG. 5 illustrates a wireless network, in accordance with some embodiments. Although the subject matter described herein may be implemented in any appropriate type of system using any suitable components, the embodiments disclosed herein are described in relation to a wireless network, such as the example wireless network illustrated in FIG. 5. For simplicity, the wireless network of FIG. 5 only depicts network 106, network nodes 160 and 160b, and wireless devices 110. In practice, a wireless network may further include any additional elements suitable to support communication between wireless devices or between a wireless device and another communication device, such as a landline telephone, a service provider, or any other network node or end device. Of the illustrated components, network node 160 and wireless device 110 are depicted with additional detail. The wireless network may provide communication and other types of services to one or more wireless devices to facilitate the wireless devices' access to and/or use of the services provided by, or via, the wireless network.

The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards; wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and wireless device 110 comprise various components described in more detail below. These components work together in order to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

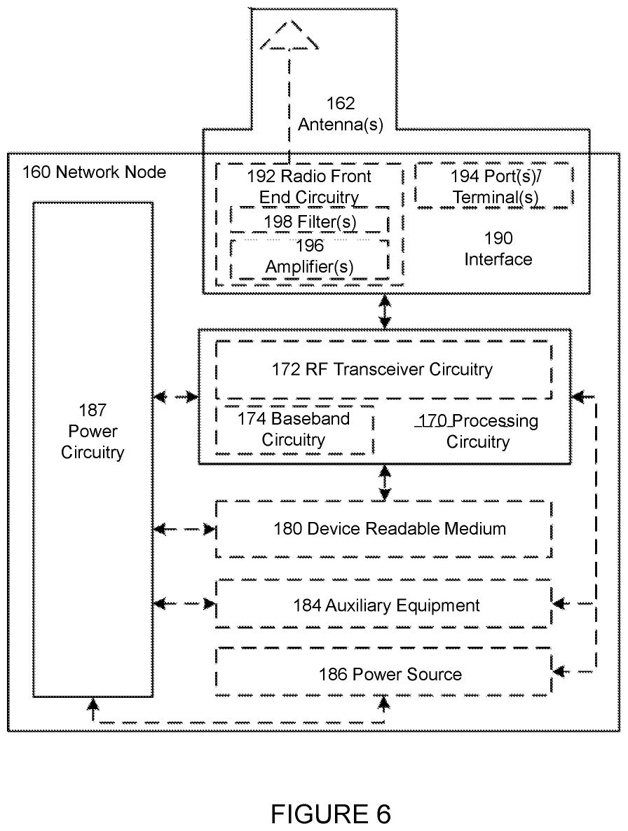

FIG. 6 illustrates an example network node 160, according to certain embodiments. As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network. Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs. As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 6, network node 160 includes processing circuitry 170, device readable medium 180, interface 190, auxiliary equipment 184, power source 186, power circuitry 187, and antenna 162. Although network node 160 illustrated in the example wireless network of FIG. 6 may represent a device that includes the illustrated combination of hardware components, other embodiments may comprise network nodes with different combinations of components. It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node. In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality. For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units.

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signalling and/or data between network node 160, network 106, and/or wireless devices 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162. Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or wireless devices via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHz. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160. For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 6 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

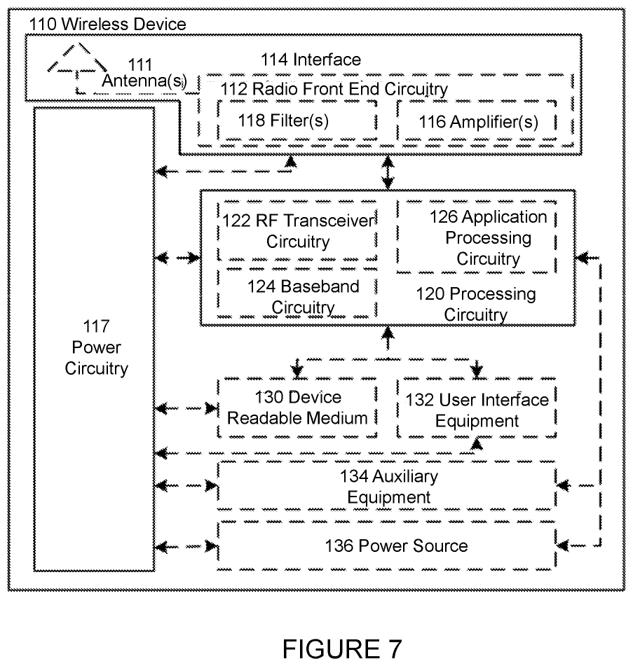

FIG. 7 illustrates an example wireless device 110. According to certain embodiments. As used herein, wireless device refers to a device capable, configured, arranged and/or operable to communicate wirelessly with network nodes and/or other wireless devices. Unless otherwise noted, the term wireless device may be used interchangeably herein with user equipment (UE). Communicating wirelessly may involve transmitting and/or receiving wireless signals using electromagnetic waves, radio waves, infrared waves, and/or other types of signals suitable for conveying information through air. In some embodiments, a wireless device may be configured to transmit and/or receive information without direct human interaction. For instance, a wireless device may be designed to transmit information to a network on a predetermined schedule, when triggered by an internal or external event, or in response to requests from the network. Examples of a wireless device include, but are not limited to, a smart phone, a mobile phone, a cell phone, a voice over IP (VoIP) phone, a wireless local loop phone, a desktop computer, a personal digital assistant (PDA), a wireless cameras, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A wireless device may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device. As yet another specific example, in an Internet of Things (IoT) scenario, a wireless device may represent a machine or other device that performs monitoring and/or measurements and transmits the results of such monitoring and/or measurements to another wireless device and/or a network node. The wireless device may in this case be a machine-to-machine (M2M) device, which may in a 3GPP context be referred to as an MTC device. As one particular example, the wireless device may be a UE implementing the 3GPP narrow band internet of things (NB-IoT) standard. Particular examples of such machines or devices are sensors, metering devices such as power meters, industrial machinery, or home or personal appliances (e.g. refrigerators, televisions, etc.) personal wearables (e.g., watches, fitness trackers, etc.). In other scenarios, a wireless device may represent a vehicle or other equipment that is capable of monitoring and/or reporting on its operational status or other functions associated with its operation. A wireless device as described above may represent the endpoint of a wireless connection, in which case the device may be referred to as a wireless terminal. Furthermore, a wireless device as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. Wireless device 110 may include multiple sets of one or more of the illustrated components for different wireless technologies supported by wireless device 110, such as, for example, GSM, WCDMA, LTE, NR, WiFi, WiMAX, or Bluetooth wireless technologies, just to mention a few. These wireless technologies may be integrated into the same or different chips or set of chips as other components within wireless device 110.

Antenna 111 may include one or more antennas or antenna arrays, configured to send and/or receive wireless signals, and is connected to interface 114. In certain alternative embodiments, antenna 111 may be separate from wireless device 110 and be connectable to wireless device 110 through an interface or port. Antenna 111, interface 114, and/or processing circuitry 120 may be configured to perform any receiving or transmitting operations described herein as being performed by a wireless device. Any information, data and/or signals may be received from a network node and/or another wireless device. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, wireless device 110 may not include separate radio front end circuitry 112; rather, processing circuitry 120 may comprise radio front end circuitry and may be connected to antenna 111. Similarly, in some embodiments, some or all of RF transceiver circuitry 122 may be considered a part of interface 114. Radio front end circuitry 112 may receive digital data that is to be sent out to other network nodes or wireless devices via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other wireless device 110 components, such as device readable medium 130, wireless device 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of wireless device 110 may comprise a SOC. In some embodiments, RF transceiver circuitry 122, baseband processing circuitry 124, and application processing circuitry 126 may be on separate chips or sets of chips. In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a wireless device may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner. In any of those particular embodiments, whether executing instructions stored on a device readable storage medium or not, processing circuitry 120 can be configured to perform the described functionality. The benefits provided by such functionality are not limited to processing circuitry 120 alone or to other components of wireless device 110, but are enjoyed by wireless device 110 as a whole, and/or by end users and the wireless network generally.

Processing circuitry 120 may be configured to perform any determining, calculating, or similar operations (e.g., certain obtaining operations) described herein as being performed by a wireless device. These operations, as performed by processing circuitry 120, may include processing information obtained by processing circuitry 120 by, for example, converting the obtained information into other information, comparing the obtained information or converted information to information stored by wireless device 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be considered to be integrated.

User interface equipment 132 may provide components that allow for a human user to interact with wireless device 110. Such interaction may be of many forms, such as visual, audial, tactile, etc. User interface equipment 132 may be operable to produce output to the user and to allow the user to provide input to wireless device 110. The type of interaction may vary depending on the type of user interface equipment 132 installed in wireless device 110. For example, if wireless device 110 is a smart phone, the interaction may be via a touch screen; if wireless device 110 is a smart meter, the interaction may be through a screen that provides usage (e.g., the number of gallons used) or a speaker that provides an audible alert (e.g., if smoke is detected). User interface equipment 132 may include input interfaces, devices and circuits, and output interfaces, devices and circuits. User interface equipment 132 is configured to allow input of information into wireless device 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from wireless device 110, and to allow processing circuitry 120 to output information from wireless device 110. User interface equipment 132 may include, for example, a speaker, a display, vibrating circuitry, a USB port, a headphone interface, or other output circuitry. Using one or more input and output interfaces, devices, and circuits, of user interface equipment 132, wireless device 110 may communicate with end users and/or the wireless network and allow them to benefit from the functionality described herein.

Auxiliary equipment 134 is operable to provide more specific functionality which may not be generally performed by wireless devices. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. wireless device 110 may further comprise power circuitry 137 for delivering power from power source 136 to the various parts of wireless device 110 which need power from power source 136 to carry out any functionality described or indicated herein. Power circuitry 137 may in certain embodiments comprise power management circuitry. Power circuitry 137 may additionally or alternatively be operable to receive power from an external power source; in which case wireless device 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of wireless device 110 to which power is supplied.

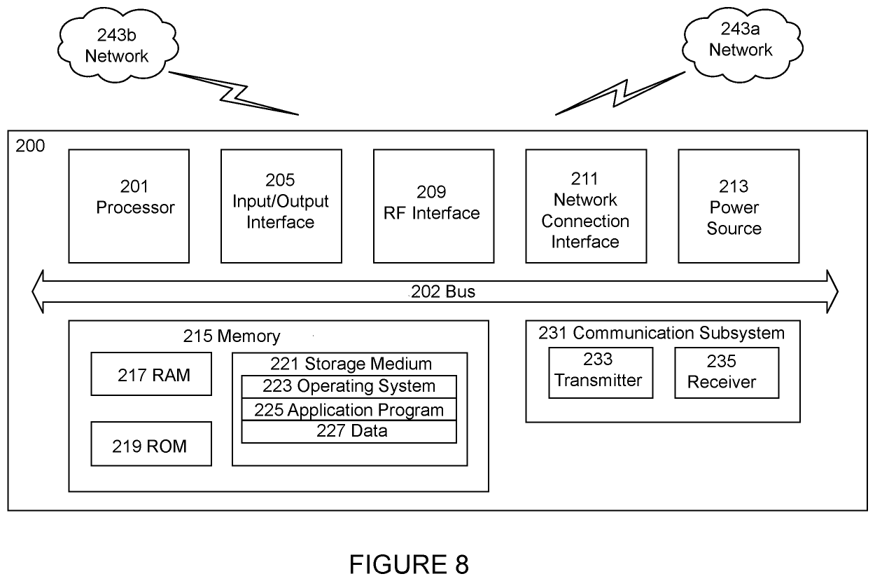

FIG. 8 illustrates one embodiment of a UE in accordance with various aspects described herein. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 00 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 6, is one example of a wireless device configured for communication in accordance with one or more communication standards promulgated by the 3^{rd} Generation Partnership Project (3GPP), such as 3GPP's GSM, UMTS, LTE, and/or 5G standards. As mentioned previously, the term wireless device and UE may be used interchangeable. Accordingly, although FIG. 8 is a UE, the components discussed herein are equally applicable to a wireless device, and vice-versa.

In FIG. 8, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 233, and/or any other component, or any combination thereof. Storage medium 221 includes operating system 223, application program 225, and data 227. In other embodiments, storage medium 221 may include other similar types of information. Certain UEs may utilize all of the components shown in FIG. 8, or only a subset of the components. The level of integration between the components may vary from one UE to another UE. Further, certain UEs may contain multiple instances of a component, such as multiple processors, memories, transceivers, transmitters, receivers, etc.

In FIG. 8, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205. An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof. UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 8, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a keyboard that are stored in a non-volatile memory. Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 8, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another wireless device, UE, or base station of a radio access network (RAN) according to one or more communication protocols, such as IEEE 802.2, CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

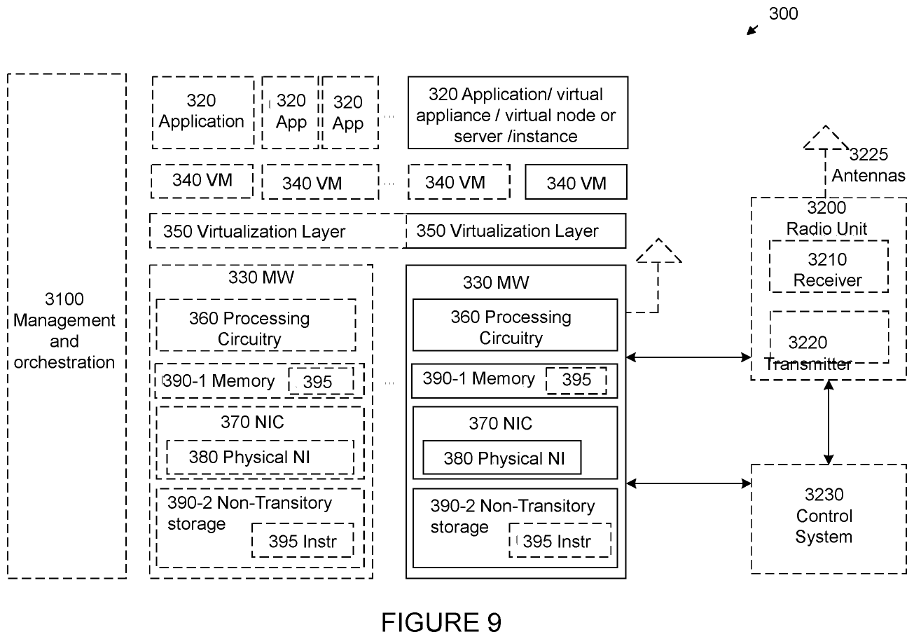

FIG. 9 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 9, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 9.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be affected with the use of control system 3230 which may alternatively be used for communication between the hardware nodes 330 and radio units 3200.

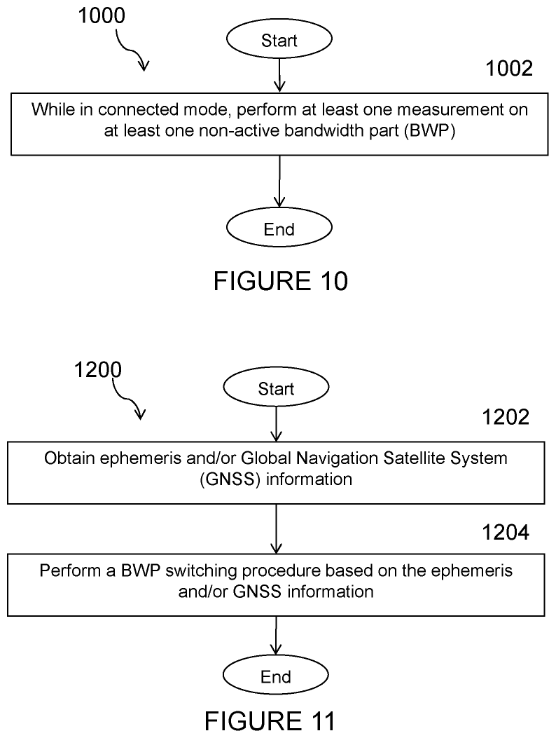

FIG. 10 depicts a method 1000 by a wireless device 10, according to certain embodiments. At step 1002, while in a connected mode, the wireless device 110 performs at least one measurement at least one non-active BWP.

In a particular embodiment, the wireless device determines at least one resource for performing the at least one measurement on the at least one non-active BWP.

In a particular embodiment, the at least one resource comprises at least one of: at least one SSB and at least one CSI-RS resource.

In a particular embodiment, the wireless device transmits, to a network node 160, an indication of a measurement capability of the wireless device to perform the at least one measurement on the at least one non-active BWP. In a particular embodiment, the capability is on a per UE basis, a per band basis, a per band combination basis, a per band in a band combination basis, or a per frequency range basis. In a particular embodiment, the measurement capability is comprises at least one of a frequency division duplex capability and a time division duplex capability. In a particular embodiment, the wireless device transmits, the frequency division duplex capability in a first message and transmits, the time division duplex capability in a second message. In a particular embodiment, the measurement capability is associated with a frequency range.

In a particular embodiment, the wireless device (1) transmits, to the network node, a first measurement capability of the wireless device to perform the at least one measurement on the at least one non-active BWP in a first frequency range and (2) transmits, to the network node, a second measurement capability of the wireless device to perform the at least one measurement on the at least one non-active BWP in a second frequency range.

In a particular embodiment, the wireless device uses a RF module to perform the at least one measurement on the at least one non-active BWP. In a particular embodiment, the wireless device uses the RF module to perform at least one measurement on at least one active BWP.

In a particular embodiment, the wireless device transmits, to a network node, a message indicating that the wireless device needs a measurement gap to perform the at least one measurement on the at least one non-active BWP.

In a particular embodiment, the wireless device receives, from a network node, a measurement gap configuration, the measurement gap configuration comprising at last one measurement gap during which the at least one measurement on the at least one non-active BWP is performed. In a particular embodiment, the measurement gap configuration comprises at least one of a length, a periodicity, and/or a starting offset for the measurement gap. In a particular embodiment, performing the at least one measurement on the at least one non-active BWP comprises performing the at least one measurement on the at least one non-active BWP during the measurement gap.

In a particular embodiment, the wireless device transmits, to a network node, a measurement report comprising information associated with the at least one measurement performed during the at least one non-active BWP. In a particular embodiment, the measurement report is transmitted in response to detecting a trigger event and/or a fulfillment of a trigger condition. In a particular embodiment, detecting the trigger event and/or the fulfillment of the trigger condition comprises at least one of: determining that a measured RSRP, RSRQ, SNR, and/or RSSI for an active BWP falls below a threshold; determining that a measured pathloss of an active BWP exceeds a threshold; determining that a distance between a location of the wireless device and a reference point of a cell associated with an active BWP exceeds a threshold; determining that an expected serving time for at least one beam on an active BWP is less than a threshold; and receiving a message from a network node that requests the measurement report. In a particular embodiment, the measurement report is transmitted on a periodic or semi-periodic basis.

FIG. 11 depicts another method 1200 by a wireless device 110, according to certain embodiments. At step 1202, the wireless device obtains ephemeris and/or GNSS information. At step 1204, the wireless device performs a BWP switching procedure based on the ephemeris and/or GNSS information.

In a particular embodiment, obtaining the ephemeris and/or GNSS information comprises receiving the ephemeris information from a network node.

In a particular embodiment, the wireless device transmits, to a network node, an indication of a location of the wireless device. In a particular embodiment, the indication of the location of the wireless device is transmitted on a periodic or semi-periodic basis. In a particular embodiment, the indication of the location of the wireless device is transmitted in response to detecting a trigger event and/or a fulfillment of a trigger condition. In a particular embodiment, detecting the trigger event and/or the fulfillment of the trigger condition comprises: determining that a distance between the location of the wireless device and a reference point of a cell associated with an active BWP exceeds a threshold.

In a particular embodiment, the wireless device receives, from a network node 160, an indication that the wireless device is to perform the BWP switching procedure. In a particular embodiment, the indication to perform the BWP switching procedure is received via at least one of a RRC reconfiguration, a MAC CE, and DCI.

In a particular embodiment, the BWP switching procedure is performed based on a BWP frequency reuse arrangement.

In a particular embodiment, the wireless device receives the BWP frequency reuse arrangement from a network node.

In a particular embodiment, the wireless device measures a location of the wireless device using the GNSS.

In a particular embodiment, obtaining the ephemeris information comprises receiving the ephemeris information from a network node.

In a particular embodiment, the BWP switching procedure is further performed based on detecting a trigger event and/or a fulfillment of a trigger condition.

In a particular embodiment, detecting the trigger event and/or the fulfillment of the trigger condition comprises: determining that a distance between the location of the wireless device and a reference point of a cell associated with an active BWP exceeds a threshold; and determining that a distance between a location of the wireless device and a reference point of a cell applicable for a non-active BWP is smaller than a threshold.

In a particular embodiment, the wireless device transmits, to a network node, a message indicating that the BWP switching procedure has been performed.

In a particular embodiment, the message indicates a change from a first active BWP to a second active BWP.

In a particular embodiment, the message comprises a MAC CE or an RRC message.

In a particular embodiment, the BWP switching procedure is further performed based on at least one measurement, at least one serving beam, a traffic load, and/or another metric.

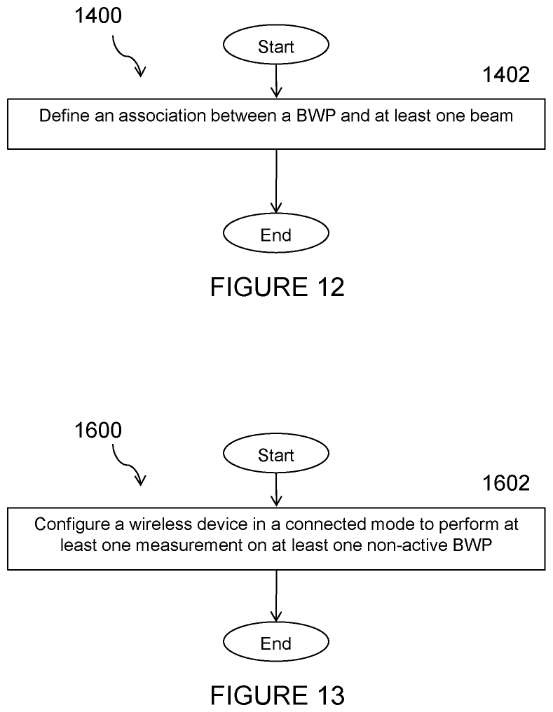

FIG. 12 depicts another method 1400 by a wireless device 110, according to certain embodiments. At step 1402, the wireless device 110 defines an association between a BWP and at least one beam.

In a particular embodiment, the association is defined via a reference signal (RS).

In a particular embodiment, the RS comprises a CSI-RS or a SSB.

In a particular embodiment, defining the association comprises at least one of: defining at least one RRC parameter and/or field; indicating the association in at least one of SI, DCI, or MAC CE; associating the BWP and the beam with a characteristic such as a time or frequency allocation; associating the BWP and the beam with a predefined tabular value; associating a BWP index with a TCI state index; and/or associating a BWP index with a spatial relation index.

In a particular embodiment, wherein the wireless device is in a connected state, an idle state, or an inactive state.

In a particular embodiment, the association is defined during or in association with a procedure, wherein the procedure comprises a random access procedure, downlink control reception, or downlink data reception.

In a particular embodiment, defining the association between the BWP and the at least one beam comprises defining the association between the BWP and a plurality of beams.

In a particular embodiment, the plurality of beams comprises a default beam.

In a particular embodiment, the default beam comprises a beam having a lowest index.

In a particular embodiment, the wireless device receives an indication, from a network node, of the default beam.

In a particular embodiment, the wireless device simultaneously performs a BWP switching procedure and a beam switching procedure based on the association between the BWP and the at least one beam.

In a particular embodiment, the beam switching procedure comprises switching from a first BWP to a second BWP.

In a particular embodiment, performing the beam switching procedure comprises switching from a first beam associated with a first BWP to a second beam associated with a second BWP.

In a particular embodiment, the wireless device detects a trigger and/or a fulfillment of a condition, and wherein the simultaneous performance of the BWP switching procedure and the beam switching procedure is performed in response to detecting the trigger and/or the fulfillment of the condition.

In a particular embodiment, the wireless device detects the trigger or the fulfillment of the condition comprises receiving a message from a network node. In a particular embodiment, the message comprises a RRC message, a MAC CE, or DCI. In a particular embodiment, detecting the trigger or the fulfillment of the condition comprises detecting an expiration of a timer.

In a particular embodiment, the trigger and/or the fulfillment of the condition triggers the BWP switching procedure and the beam switching procedure is performed simultaneously with and/or based on the BWP switching procedure. In a particular embodiment, the trigger and/or the fulfillment of the condition triggers the beam switching procedure and the BWP switching procedure is performed simultaneously with and/or based on the beam switching procedure. As used herein, “simultaneous” or “simultaneously” does not require that the procedures are performed at exactly the same time. Rather, the terms “simultaneous” and “simultaneously” merely mean that performing the BWP switching procedure or the beam switching procedure results in performance of the associated counterpart procedure. Thus, the performance of the associated counterpart procedure is based on the performance of the BWP switching procedure or beam switching procedure that is initiated first. Some delay can be tolerated between the performance of the switching procedures and still be considered “simultaneous.”

In a particular embodiment, the wireless device is configured for more than one active BWP.

FIG. 13 depicts a method 1600 by a network node 160, according to certain embodiments. At step 1602, the network node configures a wireless device 110 in a connected mode to performing at least one measurement on at least one non-active BWP.

In a particular embodiment, the network node transmits, to the wireless device, an indication of at least one resource for performing the at least one measurement on the at least one non-active BWP.

In a particular embodiment, the at least one resource comprises at least one of: at least one SSB and at least one CSI-RS resource.

In a particular embodiment, the network node receives, from a wireless device, an indication of a measurement capability of the wireless device to perform the at least one measurement on the at least one non-active BWP.

In a particular embodiment, the capability is on a per UE basis, a per band basis, a per band combination basis, or a per band in a band combination basis.

In a particular embodiment, the measurement capability is comprises at least one of a frequency division duplex capability and a time division duplex capability.

In a particular embodiment, the network node receives, from the wireless device, the frequency division duplex capability in a first message and receives, from the wireless device, the time division duplex capability in a second message.

In a particular embodiment, the measurement capability is associated with a frequency range.

In a particular embodiment, the network node (1) receives, from the wireless device, a first measurement capability of the wireless device to perform the at least one measurement on the at least one non-active BWP in a first frequency range and (2) receives, from the wireless device, a second measurement capability of the wireless device to perform the at least one measurement on the at least one non-active BWP in a second frequency range.

In a particular embodiment, the network node configures the wireless device to use a RF module to perform the at least one measurement on the at least one non-active BWP.

In a particular embodiment, the network node configures the wireless device to use the RF module to perform at least one measurement on at least one active BWP.

In a particular embodiment, the network node receives, from the wireless device, a message indicating that the wireless device needs a measurement gap to perform the at least one measurement on the at least one non-active BWP.

In a particular embodiment, the network node transmits, to a wireless device, a measurement gap configuration, the measurement gap configuration comprising at last one measurement gap during which the at least one measurement on the at least one non-active BWP is performed.

In a particular embodiment, the measurement gap configuration comprises at least one of a length, a periodicity, and/or a starting offset for the measurement gap.

In a particular embodiment, configuring the wireless device to perform the at least one measurement on the at least one non-active BWP comprises configuring the wireless device to perform the at least one measurement on the at least one non-active BWP during the measurement gap.

In a particular embodiment, the network node receives, from a wireless device, a measurement report comprising information associated with the at least one measurement performed during the at least one non-active BWP.

In a particular embodiment, the measurement report is received in response to the wireless device detecting a trigger event and/or a fulfillment of a trigger condition.

In a particular embodiment, the network node configures the wireless device to detect the trigger event and/or the fulfillment of the trigger condition comprises configuring the wireless device to perform at least one of: determining that a measured RSRP, RSRQ, SNR, and/or RSSI for an active BWP falls below a threshold; determining that a measured pathloss of an active BWP exceeds a threshold; determining that a distance between a location of the wireless device and a reference point of a cell associated with an active BWP exceeds a threshold; determining that an expected serving time for at least one beam on an active BWP is less than a threshold; and receiving a message from a network node that requests the measurement report.

In a particular embodiment, the measurement report is received on a periodic or semi-periodic basis.

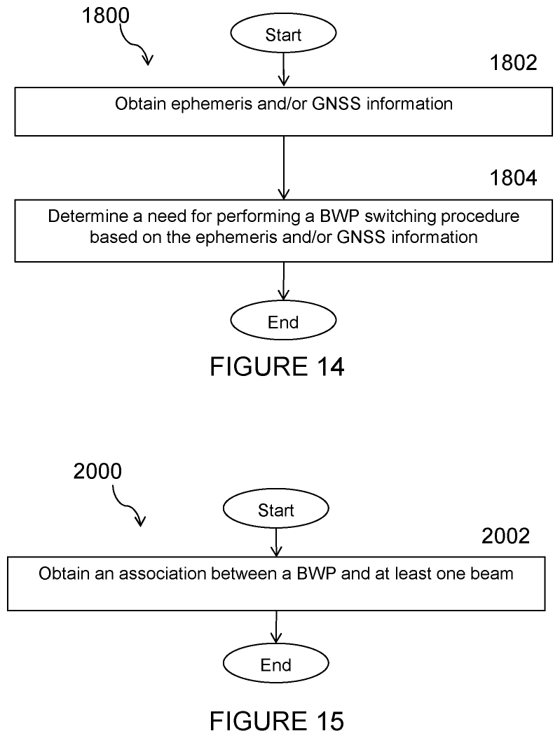

FIG. 14 depicts another method 1800 by a network node 160, according to certain embodiments. At step 1802, the network node obtains ephemeris and/or GNSS information. At step 1804, the network node determines a need for performing a BWP switching procedure based on the ephemeris and/or GNSS information.

In a particular embodiment, the network node transmits the ephemeris and/or GNSS information to a wireless device.

In a particular embodiment, the network node transmits a message to a wireless device to trigger a performance of the BWP switching procedure by the wireless device.

In a particular embodiment, the network node configures the wireless device to perform the BWP switching procedure based on the ephemeris and/or GNSS information.

In a particular embodiment, the network node receives, from the wireless device, an indication of a location of the wireless device.

In a particular embodiment, the indication of the location of the wireless device is received on a periodic or semi-periodic basis.

In a particular embodiment, the network node configures the wireless device to transmit the indication of the location of the wireless device in response to the wireless device detecting a trigger event and/or a fulfillment of a trigger condition.

In a particular embodiment, the trigger event and/or the fulfillment of the trigger condition comprises: a distance between the location of the wireless device and a reference point of a cell associated with an active BWP exceeding a threshold.

In a particular embodiment, the network node transmits, to a wireless device, an indication that the wireless device is to perform the BWP switching procedure.

In a particular embodiment, the indication to perform the BWP switching procedure is transmitted via at least one of a RRC reconfiguration, a MAC CE, and DCI.

In a particular embodiment, the network node configures the wireless device to perform the BWP switching procedure based on a BWP frequency reuse arrangement.

In a particular embodiment, the network node transmits the BWP frequency reuse arrangement to the wireless device.

In a particular embodiment, the network node configures the wireless device to perform the BWP switching procedure based on detecting a trigger event and/or a fulfillment of a trigger condition.

In a particular embodiment, the trigger event and/or the fulfillment of the trigger condition comprises: a distance between the location of the wireless device and a reference point of a cell associated with an active BWP exceeding a threshold; and a distance between a location of the wireless device and a reference point of a cell applicable for a non-active BWP being smaller than a threshold.

In a particular embodiment, the network node receives, from a wireless device, a message indicating that the BWP switching procedure has been performed.

In a particular embodiment, the message indicates a change from a first active BWP to a second active BWP.

In a particular embodiment, the message comprises a MAC CE or an RRC message.

In a particular embodiment, the network node configures the wireless device to perform the BWP switching procedure based on at least one measurement, at least one serving beam, a traffic load, and/or another metric.

FIG. 15 depicts another method 2000 by a network node 160, according to certain embodiments. At step 2002, the network node obtains an association between a BWP and at least one beam.

In a particular embodiment, obtaining the association between the BWP and the at least one beam comprises defining, by the network node, the association between the BWP and the at least one beam.

In a particular embodiment, obtaining the association between the BWP and the at least one beam comprises receiving the association from a wireless device.

In a particular embodiment, the association is defined via a RS.

In a particular embodiment, the RS comprises a CSI-RS or a SSB.

In a particular embodiment, obtaining the association comprises at least one of: defining at least one RRC parameter and/or field; indicating the association in at least one of SI, DCI, or MAC CE; associating the BWP and the beam with a characteristic such as a time or frequency allocation; associating the BWP and the beam with a predefined tabular value; associating a BWP index with a TCI state index; and/or associating a BWP index with a spatial relation index.

In a particular embodiment, the wireless device is in a connected state, an idle state, or an inactive state.

In a particular embodiment, the association is defined during or in association with a procedure, wherein the procedure comprises a random access procedure, downlink control reception, or downlink data reception.

In a particular embodiment, the association between the BWP and the at least one beam comprises an association between the BWP and a plurality of beams.

In a particular embodiment, the plurality of beams comprises a default beam.

In a particular embodiment, the default beam comprises a beam having a lowest index.

In a particular embodiment, the network node transmits an indication, to a wireless device, of the default beam.

In a particular embodiment, the network node configures the wireless device to simultaneously perform a BWP switching procedure and a beam switching procedure based on the association between the BWP and the at least one beam.

In a particular embodiment, configuring the wireless device to perform the beam switching procedure comprises configuring the wireless device to switch from a first BWP to a second BWP.

In a particular embodiment, configuring the wireless device to perform the beam switching procedure comprises configuring the wireless device to switch from a first beam associated with a first BWP to a second beam associated with a second BWP.

In a particular embodiment, the network node configures the wireless device to detect a trigger and/or a fulfillment of a condition, and wherein the simultaneous performance of the BWP switching procedure and the beam switching procedure is performed by the wireless device in response to detecting the trigger and/or the fulfillment of the condition.

In a particular embodiment, the trigger or the fulfillment of the condition comprises transmitting a message to the wireless device.

In a particular embodiment, the message comprises a RRC message, a MAC CE, or DCI.

In a particular embodiment, configuring the wireless device to detect the trigger or the fulfillment of the condition comprises configuring the wireless device to detect an expiration of a timer.

In a particular embodiment, the trigger and/or the fulfillment of the condition triggers the BWP switching procedure and the beam switching procedure to be performed simultaneously with the BWP switching procedure.

In a particular embodiment, the trigger and/or the fulfillment of the condition triggers the beam switching procedure and the BWP switching procedure to be performed simultaneously with the beam switching procedure.

In a particular embodiment, the network node configures the wireless device for more than one active BWP.

Modifications, additions, or omissions may be made to the systems and apparatuses described herein without departing from the scope of the disclosure. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods described herein without departing from the scope of the disclosure. The methods may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure.

1. A method by a wireless device, the method comprising:
while in a connected mode, performing at least one measurement on at least one non-active bandwidth part, BWP, and transmitting, to a network node, a measurement report comprising information associated with the at least one measurement performed during the at least one non-active BWP.

2. The method of claim 1, further comprising determining at least one resource for performing the at least one measurement on the at least one non-active BWP, wherein the at least one resource comprises at least one of: at least one Synchronization Signal Block and at least one Channel State Information-Reference Signal resource.

3. The method of claim 1, further comprising transmitting, to a network node, an indication of a measurement capability of the wireless device to perform the at least one measurement on the at least one non-active BWP, wherein the capability is on a per UE basis, a per band basis, a per band combination basis, a per band in a band combination basis, or a per frequency range basis.

4. The method of claim 3, wherein the measurement capability comprises at least one of:
a frequency division duplex capability; and
a time division duplex capability.

5. The method of claim 1, further comprising:
transmitting, to the network node, a first measurement capability of the wireless device to perform the at least one measurement on the at least one non-active BWP in a first frequency range; and
transmitting, to the network node, a second measurement capability of the wireless device to perform the at least one measurement on the at least one non-active BWP in a second frequency range.

6. The method of claim 1, further comprising using a radio frequency, RF, module to perform the at least one measurement on the at least one non-active BWP.

7. The method of claim 6, further comprising using the RF module to perform at least one measurement on at least one active BWP.

8. The method of claim 1, further comprising transmitting, to a network node, a message indicating that the wireless device needs a measurement gap to perform the at least one measurement on the at least one non-active BWP.

9. The method of claim 1, further comprising receiving, from a network node, a measurement gap configuration, the measurement gap configuration comprising at last one measurement gap during which the at least one measurement on the at least one non-active BWP is performed.

10. The method of claim 9, wherein the measurement gap configuration comprises one or more of a length, a periodicity, and a starting offset for the measurement gap.

11. The method of claim 9, wherein performing the at least one measurement on the at least one non-active BWP comprises performing the at least one measurement on the at least one non-active BWP during the measurement gap.

12. (canceled)

13. The method of claim 1, wherein the measurement report is transmitted in response to one or both detecting a trigger event and a fulfillment of a trigger condition.

14. The method of claim 13, wherein detecting the trigger event and/or the fulfillment of the trigger condition comprises at least one of:
determining that a measured Reference Signal Received Power, Reference Signal Received Quality, Signal Interference to Noise Ratio, and/or Reference Signal Strength Indicator, for an active BWP falls below a threshold;
determining that a measured pathloss of an active BWP exceeds a threshold;
determining that a distance between a location of the wireless device and a reference point of a cell associated with an active BWP exceeds a threshold;
determining that an expected serving time for at least one beam on an active BWP is less than a threshold; and
receiving a message from a network node that requests the measurement report.

15. The method of claim 13, wherein the measurement report is transmitted on a periodic or semi-periodic basis.

16.-50. (canceled)

51. A method by a network node, the method comprising:
configuring a wireless device in a connected mode to performing at least one measurement on at least one non-active bandwidth part, BWP, and receiving, from a wireless device, a measurement report comprising information associated with the at least one measurement performed during the at least one non-active BWP.

52. The method of claim 51 further comprises transmitting, to the wireless device, an indication of at least one resource for performing the at least one measurement on the at least one non-active BWP, wherein the at least one resource comprises at least one of: at least one Synchronization Signal Block and at least one Channel State Information-Reference Signal resource.

53. The method of claim 51, further comprising receiving, from a wireless device, an indication of a measurement capability of the wireless device to perform the at least one measurement on the at least one non-active BWP, wherein the capability is on a per UE basis, a per band basis, a per band combination basis, a per band in a band combination basis, or a per frequency range basis.

54. The method of claim 53, wherein the measurement capability is comprises at least one of a frequency division duplex capability and a time division duplex capability.

55-99. (canceled)

100. A wireless device configured to:
while in a connected mode, perform at least one measurement on at least one non-active bandwidth part, BWP, and transmitting, to a network node, a measurement report comprising information associated with the at least one measurement performed during the at least one non-active BWP.

101. A network node configured to:
configure a wireless device in a connected mode to performing at least one measurement on at least one non-active bandwidth part, BWP, and receive, from a wireless device, a measurement report comprising information associated with the at least one measurement performed during the at least one non-active BWP.
